(19) United States
(12) Patent Application Publication
(10) Pub. No.: US 2024/0372504 A1
(43) Pub. Date: Nov. 7, 2024

(54) ROCKING SOLAR PANEL SUN TRACKING RESTRAINING MOUNTING SYSTEM

(71) Applicant: KemHi LLC, Mason, OH (US)

(72) Inventor: Darin Palmer, Mason, OH (US)

(73) Assignee: KemHi LLC, Mason, OH (US)

(21) Appl. No.: 18/647,919

(22) Filed: Apr. 26, 2024

Related U.S. Application Data
(60) Provisional application No. 63/499,332, filed on May 1, 2023.

(51) Int. Cl. H02S 20/32

(52) U.S. Cl. CPC H02S 20/32

(57) ABSTRACT

A solar power collection system is disclosed herein. The system includes an array of photovoltaic panels organized in single-axis rows that track the sun's movement from east to west to maximize solar energy capture. Each row is supported by a movable base that facilitates a rolling-rocking motion, allowing the panels to maintain optimal orientation towards the sun. The dynamic positioning is governed by a fixed restraining structure that guides the movable base along a predefined path. Structural support is further augmented by interconnecting row members that distribute the weight across the array, providing mutual support and resistance to environmental forces. The system can be anchored using various methods such as wall or structure anchors, ballast trays, or floor anchors, thus minimizing the need for invasive installations.

### CLAIM OF PRIORITY UNDER 35 U.S.C. § 119

The present Application for Patent claims priority to Provisional Application No. 63/499,332 entitled “Rocking Solar Panel Sun Tracking Restraining Mounting System” filed May 1, 2023 and hereby expressly incorporated by reference herein.

### TECHNICAL FIELD

The present disclosure generally relates to solar power collection panels, and more specifically the present disclosure relates to a system for restraining a sun tracking solar panel or array of sun tracking solar panels in the event of occurrences of natural forces in the form of wind, snow, or other forces. Particularly, the present disclosure envisages a system that restrains the sun tracking solar panels to the desired tracking profile and position.

### BACKGROUND

The field of solar energy collection has seen significant advancements over the years, particularly in the development and deployment of photovoltaic (PV) systems. These systems, which convert sunlight into electricity, are critical in harnessing solar energy, one of the most abundant renewable energy sources available. A fundamental component of these systems is the solar panel, which comprises numerous PV cells that absorb and convert sunlight into electrical energy.

To maximize the efficiency of solar energy collection, solar panels are often arranged in arrays and positioned to capture the maximum amount of sunlight. This positioning can vary from fixed systems, where panels remain stationary, to tracking systems that adjust the orientation of the panels to follow the sun's path across the sky. The latter is known to significantly increase the electrical output of the panels by maintaining an optimal angle of incidence between the solar panels and the sun's rays throughout the day.

However, tracking systems introduce additional complexities, particularly in terms of their installation, maintenance, and resilience to environmental forces. These systems typically require substantial support structures to maintain the desired orientation and position of the panels. These structures must be robust enough to withstand various environmental stresses, such as wind and snow, which can displace or damage the panels. The need for such sturdy support structures often leads to increased installation and maintenance costs, particularly due to the labor-intensive nature of the installation process and the need to adapt these systems to different terrains and environmental conditions.

Furthermore, the most cost-effective solar panel systems are those with a fixed position. Yet, the stationary nature of these systems limits their efficiency, as the angle of incidence between the panels and the sunlight remains constant, disregarding the sun's movement across the sky. Systems with tilting capabilities, including single and dual-axis tracking mechanisms, offer improved efficiency but at the expense of increased complexity and susceptibility to environmental forces. These factors make the adoption of tracking systems less viable in scenarios where ground penetration for support structures is undesirable or impossible, such as on commercial rooftops, in parking lots, or on landfills.

Therefore, there exists a need for a solar panel restraining mounting system that can provide the efficiency benefits of tracking systems while minimizing the complexities, costs, and vulnerabilities associated with the support and maintenance thereof. There exists a need for a solar panel restraining mounting system that addresses these challenges by offering a more adaptable, cost-effective, and resilient solution for maximizing solar energy collection across a wide range of installation environments.

### BRIEF SUMMARY

The present disclosure envisages a solar power collection system. The solar power collection system includes at least one photovoltaic (PV) panel; and at least one single axis movable base coupled to the at least one PV panel. In an embodiment, the movable base facilitates tracking of sun by the at least one PV panel with a rolling-rocking movement, thereby orienting a receiving face of the at least one PV panel to face from east to west to efficiently receive sunlight. In one embodiment, the movable base is coupled to a fixed restraining structure that constrains a movement of the movable base to the rolling-rocking movement along a pre-defined path to facilitate the movement of the receiving face of the at least one PV panel to face from east to west. The solar power collection system further includes a tracker drive unit mechanically coupled to the movable base to impart a mechanical drive to facilitate the rolling-rocking movement of the movable base across a substrate to position the PV panel to efficiently receive sunlight.

In one embodiment, a single axis row of PV panels is mounted to a torque tube base that performs a rolling-rocking motion within a fixed restraining structure.

In one embodiment, a single axis row of PV panels is mounted to a torque tube base, which is attached to a curved rocking structure coupled to a fixed restraining structure.

In one embodiment, the solar power collection system further includes a restraining plate having a slot defining a travel path of a rocker bolt, wherein the rocker bolt is securely attached to the movable base having a curved rocking structure.

In one embodiment, multiple single axis rows of PV panels are mechanically interconnected through a structural member, apart from the tracker drive unit, thereby enhancing stability of the solar power collection system against environmental forces.

In one embodiment, the structural member is affixed to the movable base, thereby maintaining a consistent distance between the single axis rows of PV panels during tracking movements.

In one embodiment, the solar power collection system further includes a fixed restraining plate secured on the structural member, wherein the fixed restraining plate is coupled to the movable base of the multiple single axis rows of PV panels, further stabilizing the assembly.

In one embodiment, the structural member is anchored in place by at least one of the following methods: (i) using ballast weight, (ii) securing to the floor, or (iii) attaching to an existing fixed structure, thereby restraining the structural member in a stationary position.

In one embodiment, the structural member is coupled to a fixed base of multiple single axis rows of PV panels where the axis is rotating but not rolling.

In one embodiment, the torque tube rolls-rocks on the torque tube base that is shaped to reduce the drop in elevation of the center of mass of the solar power collection system when the panels are inclined at an angle ranging from about 90 degrees east to about 90 degrees west.

In one embodiment, the curve in the torque tube base in which the torque tube is rolling is shaped to reduce the drop in elevation of the center of mass of the system when the panels are inclined at an angle ranging from about 90 degrees east to about 90 degrees west.

The present disclosure envisages a solar power collection system. The system includes an array of photovoltaic (PV) panels aligned in at least one single axis row for generating electricity from sunlight; a tracker unit configured to operate a driveline, which rotates each single axis row east to west to track the sun; at least one base supporting each PV single axis row, wherein the base is connected to an interconnecting row member that provides structural support to the array by utilizing the weight of each row to support adjacent rows during external force events. In one embodiment, the interconnecting row member is attachable to a wall/structure anchor, a ballast tray, or a floor anchor, facilitating stability in various installation environments and reducing the need for floor attachments.

In one embodiment, the solar power collection system further includes a restraining plate attached to the base, wherein the restraining plate allows for tracking movement freedom while constraining the base to a defined path, enhancing stability against external forces.

In one embodiment, the restraining plate is connected to the interconnecting row member, allowing each single axis row to support the other single axis rows in the case of the external force events.

In one embodiment, the interconnecting row member includes a configuration that moves with a movable base of each single axis row as it tracks the sun.

In one embodiment, the restraining plate includes a path for a bolt that is attached to the base and free to move within the path, allowing the base to maintain a desired position during tracking movements.

In one embodiment, the restraining plate is designed to keep the center of weight of the system level during rolling and rocking movements of the base, preventing offsetting weight that could add to the impact of external forces on the system.

In one embodiment, the restraining plate is curved to maintain the center of mass of the PV system at a constant elevation during tracking movements, reducing the force required to reposition the system and enhancing resistance to external force events.

In one embodiment, the restraining plate is attachable to a fixed base, which is connected to the interconnecting row member.

In one embodiment, the wall/structure anchor serves as an anchor point for the array.

In one embodiment, the ballast tray is weighed down with ballast blocks, thereby facilitating anchoring the system without penetrating an installation surface.

The present disclosure further envisages a solar power collection system. The solar power collection system includes multiple PV panels each mounted on square torque tubes and circular torque tubes supported on multiple restraining plates that support single-axis movement. In an embodiment, the restraining plates, have either a rolling square type configuration or a rolling circle type configuration for supporting the square torque tubes and the circular torque tubes respectively. Such configuration of the restraining plates facilitate stabilization of a center of weight of the solar power collection system during tracking motions of the PV panels.

In one embodiment, each rolling square type restraining plate or rolling circle type restraining plate is connected to a fixed base that is coupled to an interconnecting row member, which in turn is attached to one of a wall/structure anchor, a ballast tray, or a floor anchor.

In one embodiment, the restraining plates are specifically configured to permit only the necessary movements of the torque tubes associated with tracking the sun from east to west, thereby optimizing energy capture and maintaining system stability.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a schematic view of a solar power collection system, in accordance with an embodiment of the present subject matter.

FIG. 2 illustrates a three-dimensional view of a solar power collection system, in accordance with an embodiment of the present subject matter.

FIG. 3a illustrates a schematic side view of a photovoltaic (PV) panel, which forms part of a solar power collection system, in accordance with an embodiment of the present subject matter.

FIG. 3b illustrates a schematic view of a portion of a solar power collection system, wherein the photovoltaic (PV) panel is shown supported at a 30-degree angle by the moving rocker base, in accordance with an embodiment of the present subject matter.

FIG. 4 illustrates a three-dimensional view of a portion of a solar power collection system, in accordance with an embodiment of the present subject matter.

FIG. 5 illustrates a schematic view of a solar power collection system including a rolling circle restraining plate and rolling square restraining plate, in accordance with another embodiment of the present subject matter.

FIG. 6a illustrates a side view of the rolling circle restraining plate used in the solar power collection system (with support plate profile to maintain the elevation of the center of mass of the panel), in accordance with an embodiment of the present subject matter.

FIG. 6b illustrates a side view of the rolling circle restraining plate, which allows the center of mass to drop as it tilts, in accordance with an embodiment of the present subject matter.

FIG. 7 illustrates a perspective view of the wall/structure anchor that connects the interconnecting row member to a wall or fixed structure as an anchor point for the array.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

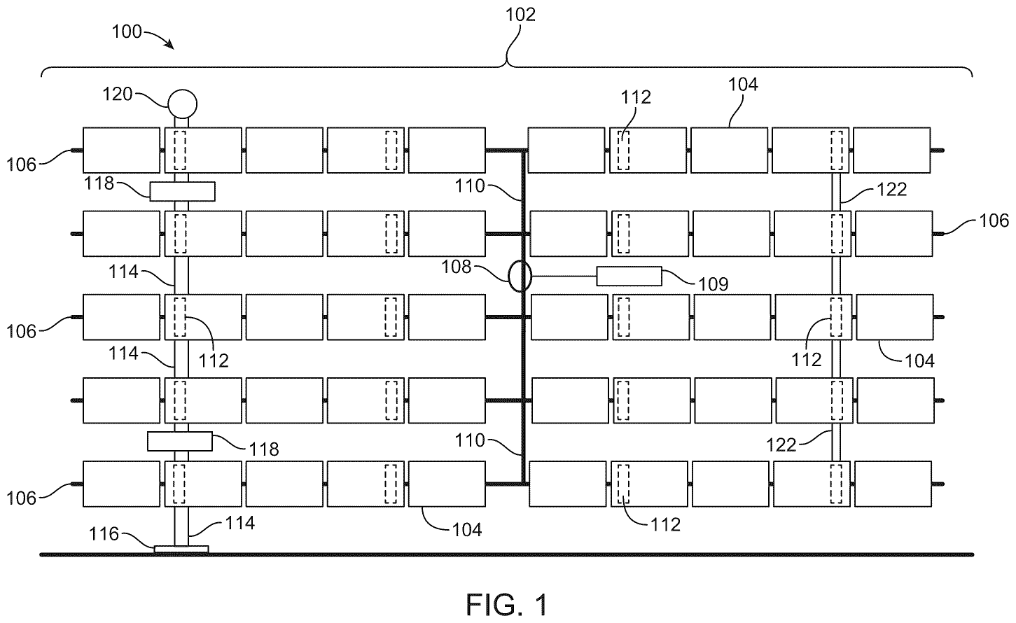

FIG. 1 illustrates a schematic view of a solar power collection system 100 (interchangeably referred to as system 100), in accordance with an embodiment of the present subject matter. The system 100 comprises an array 102 of photovoltaic (PV) panels 104. The PV panels 104 are organized into rows 106 that align along a single axis for facilitating the conversion of sunlight into electrical energy. Each row 106 of PV panels 104 is supported by at least one base 112. The bases 112 facilitate the rotational movement of the PV panels 104 along the single axis, allowing the panels to track the sun's movement from east to west.

A motor 108 is operatively connected to a driveline 110 that runs through each row 106 for initiating and sustaining the east-west rotational tracking. The use of the motor 108 and driveline 110 into the system 100 is designed to ensure that each PV panel 104 is consistently oriented in an optimal position relative to the sun's path to maximize energy absorption and electricity generation efficiency. In accordance with one embodiment of the present invention, the motor 108 may be operated using a control unit 109, where the motor 108 and the control unit 109 together constitute a tracker unit. In one embodiment, the control unit 109 may be provided with a tracking schedule specific to a deployment location of the system 100 for controlling the movement of the PV panels 104 throughout the day.

In one embodiment, the bases 112 are further interconnected by row members 114, which extend across and connect adjacent rows 106 of PV panels 104. This interconnection via the row members 114 facilitates the distribution of the structural load, utilizing the weight of each individual row to provide mutual support and enhance the overall stability of the array 102, under the influence of external forces such as wind.

To augment the structural integrity of the system 100, the interconnecting row members 114 are designed to be attachable to various anchoring mechanisms. Some examples of the anchoring mechanisms include a wall/structure anchor 116, a ballast tray 118, or a floor anchor 120, where each of the aforementioned examples provide additional support and reduce the dependency on penetrating attachments that may otherwise compromise the integrity of the installation surface, such as a rooftop.

In accordance with one embodiment, some rows 106 include an interconnecting row member 122 that is affixed the base 112. In one embodiment, the base 112 is a moving rocker base 112. Such a configuration of the moving rocker base 112 and the interconnecting row member 122 allows for the necessary movement induced by the tracking motor 108 while maintaining the structural integrity and alignment of the array 102. The implementation of both stationary interconnecting row members 114 and the interconnecting row members 122 attached to the moving rocker bases 112 contribute to a robust system architecture capable of withstanding environmental or external forces while maintaining operational efficiency.

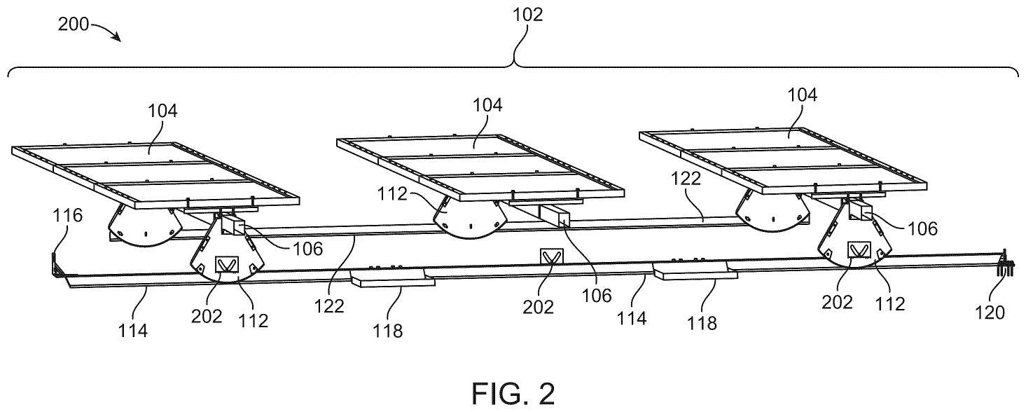

FIG. 2 illustrates a three-dimensional view 200 of a solar power collection system, in accordance with an embodiment of the present subject matter. As shown in FIG. 2, the system comprises the array 102 of photovoltaic (PV) panels 104 configured in alignment along a single axis in rows 106 to facilitate the conversion of sunlight into electrical energy. Each PV panel 104 within the single axis rows 106 is mounted upon the base 112. The base 112 is configured for supporting the structure of the PV panels 104 and enabling their movement to track the path of the sun.

As shown in FIG. 2, the base 112 includes a restraining plate 202. In accordance with an embodiment of the present subject matter, the restraining plate 202 is configured to permit freedom of tracking movement while simultaneously restricting motion of the base 112 to a designated path determined by the restraining plate 202. The dual functionality of the restraining plate 202 ensures that while the base 112 can move to follow the sun's trajectory from east to west, the base 112 does so in a controlled manner, thus preserving the optimal orientation of the PV panels 104 for efficient solar energy capture.

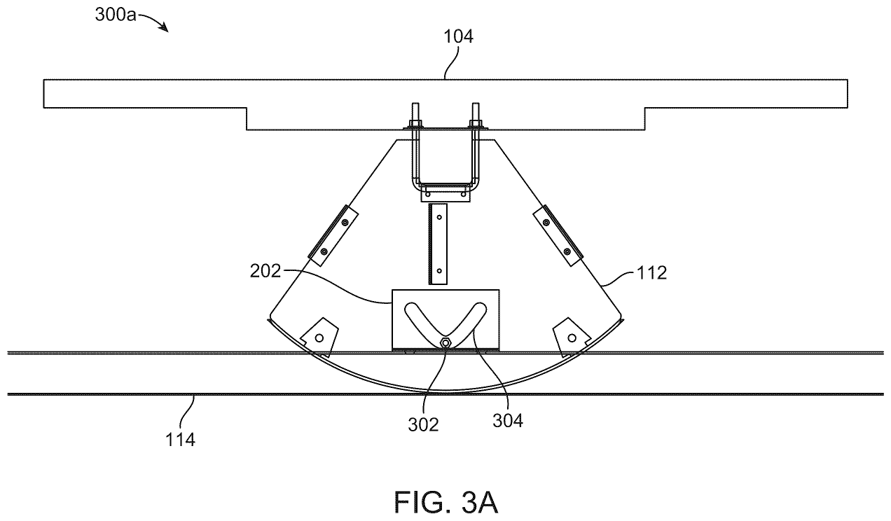

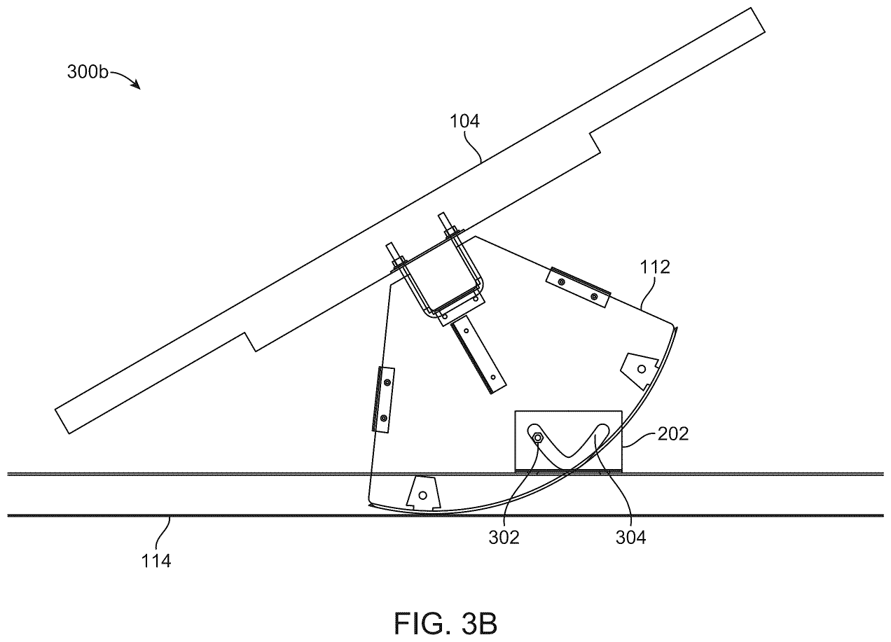

Attached to the base 112 is the interconnecting row member 114, which extends to engage with the bases 112 of adjacent rows 106. The interconnecting row member 114 facilitates unifying the array 102, allowing the rows 106 to provide mutual structural support, particularly during wind events where the stability of the array 102 may be impacted. The interconnecting row member 114 can be anchored using various methods, including a wall or structure anchor 116, a ballast tray 118, or a floor anchor 120. The choice of anchoring mechanism can be tailored to suit the specific installation environment and is aimed at reducing the necessity for floor penetrations, which is especially beneficial in rooftop installations where maintaining the integrity of the roof is a consideration. It is to be noted that the restraining plate 202 is firmly attached to the interconnecting row member 114, while the rocker base 112 is attached to the restraining plate 202. This aspect of the restraining plate 202 is better understood with reference to FIG. 3A and its corresponding explanation in the subsequent sections of the present disclosure. Also shown in FIG. 2 is the interconnected row member 122, which has been described in the previous sections of the present disclosure.

FIG. 3a illustrates schematic side view of a photovoltaic (PV) panel 104, which forms part of a solar power collection system 100, in accordance with an embodiment of the present subject matter. As shown in FIG. 3a, the PV panel 104 is mounted on a support structure comprising the single-axis row. The PV panel 104 is shown in a 0-degree position, indicative of a neutral stance with respect to the direction of sunlight. The panel 104 is supported by the moving rocker base 112, which facilitates the necessary movement for tracking the sun. The rocker moving rocker base 112 is characterized by its ability to pivot, allowing the PV panel 104 to rotate or tilt to follow the sun's trajectory. As mentioned previously, the movement of the PV panels 104 is facilitated by the tracking unit which includes the motor 108 and the control unit 109 (as shown in FIG. 1).

As shown in FIG. 3a, the movement of the moving rocker base 112 is facilitated by a connection thereof to a restraining plate 202 via a bolt 302. The bolt 302 is securely fastened to the moving rocker base 112 and is configured to traverse within a path 304 defined by the restraining plate 202. Such a configuration of the moving rocker base 112, the restraining plate 202, and the bolt 302 allows for controlled movement of the moving rocker base 112, thereby guiding the PV panel 104 in its sun-tracking motion while preventing any extraneous or uncontrolled movements that could misalign the PV panel or reduce the efficiency of energy collection.

The restraining plate 202 is in turn connected to the interconnecting row member 114, thereby providing a linkage between the different rows 106 within the array 102. The interconnecting row member 114 facilitates maintaining the structural integrity of the solar power collection system 100 by ensuring that the individual rows 106 are supported and stabilized against each other in response to environmental forces such as wind.

FIG. 3b illustrates a schematic view 300b of a portion of a solar power collection system 100, wherein the photovoltaic (PV) panel 104 is shown supported at a 30-degree angle by the moving rocker base 112. The configuration of the PV panel 104 is depicts an operational position configured to capture sunlight when the sun is positioned at either a westerly or easterly angle of 30 degrees relative to the PV panel 104.

The moving rocker base 112 functions as a support structure for the PV panel 104, thereby enabling the PV panel 104 to tilt to the requisite angle for optimal solar energy collection. The angling of the PV panel 104 is achieved through the action of the bolt 302, which is secured to the moving rocker base 112. The bolt 302—is positioned within the path 304 defined within the restraining plate 202. The placement of the bolt 302—within the path 304 is such that it is located towards the upper left region, allowing for the securement of the panel 104 in the depicted inclined position.

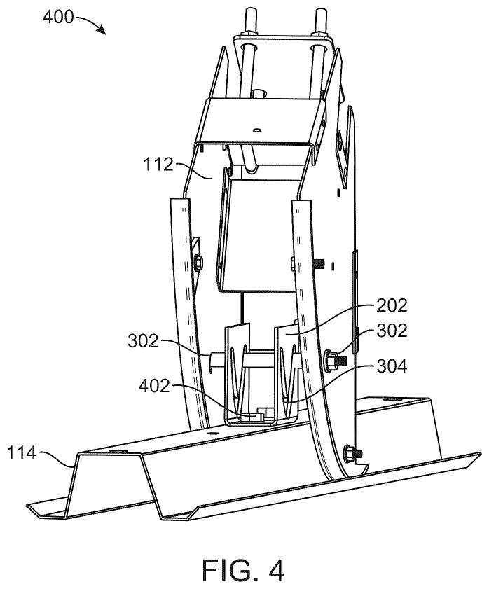

FIG. 4 illustrates a three-dimensional view 400 of a portion of a solar power collection system 100, in accordance with an embodiment of the present subject matter. As shown in FIG. 4, the moving rocker base 112 is set at a 30-degree angle, a position that is indicative of the operational posture assumed for tracking the sun at specific times of the day, such as when it is positioned at an angle 30 degrees east or west of the array.

As shown in FIG. 4, the restraining plate 202 is secured to the interconnecting row member 114 by means of a fastener attachment 402. In an embodiment, the fastener attachment 402 may be a nut/bolt attachment. Such connection of the restraining plate to the interconnecting row member 114 depicts the integration of the restraining plate 202 into the broader structural framework of the solar power collection system 100, that facilitates provision of stability and cohesion to the entire assembly.

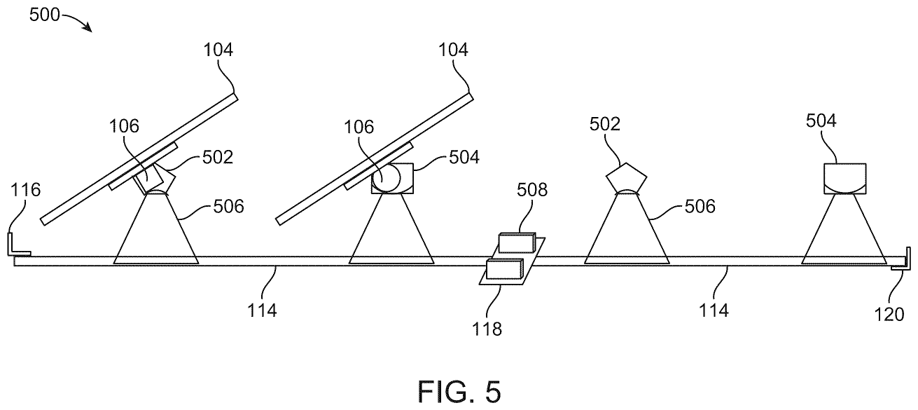

FIG. 5 illustrates a schematic view 500 of a solar power collection system 100, in accordance with another embodiment of the present subject matter. As shown in FIG. 5, the photovoltaic (PV) panels 104 are mounted in a manner that allows the PV panels 104 to adjust a position thereof in response to the sun's movement. In accordance with the instant embodiment, such dynamic positioning is facilitated by the use of two types of restraining plates, viz., a rolling square restraining plate 502 and a rolling circle restraining plate 504.

The rolling square restraining plate 502 is coupled with a square single-axis torque tube, while the rolling circle restraining plate 504 is associated with a circular single-axis torque tube. Both types of restraining plates are configured to maintain the center of weight of the system 100. As the torque tubes undergo rocking and rolling motions to track the sun's trajectory, the restraining plates ensure that the movements do not cause the system to become unbalanced, especially under the influence of external environmental forces.

The restraining plates 502 and 504 are affixed to a fixed base 506, which provides a stationary foundation for the dynamic tracking activities of the PV panels 104. The fixed base 506 is connected to the interconnecting row member 114 that links the different components of the system 100, thereby enhancing the structural integrity of the solar power collection system 100.

Furthermore, the interconnecting row member 114 is attached to various anchoring mechanisms to ensure the stability of the system 100. The anchoring options include a wall or structure anchor 116, a ballast tray 118, or a floor anchor 120. The use of ballast blocks 508 (shown in FIG. 5), which can be placed in the ballast tray 118, adds additional weight to the system 100, thereby providing further anchorage and stability to counteract external environmental forces.

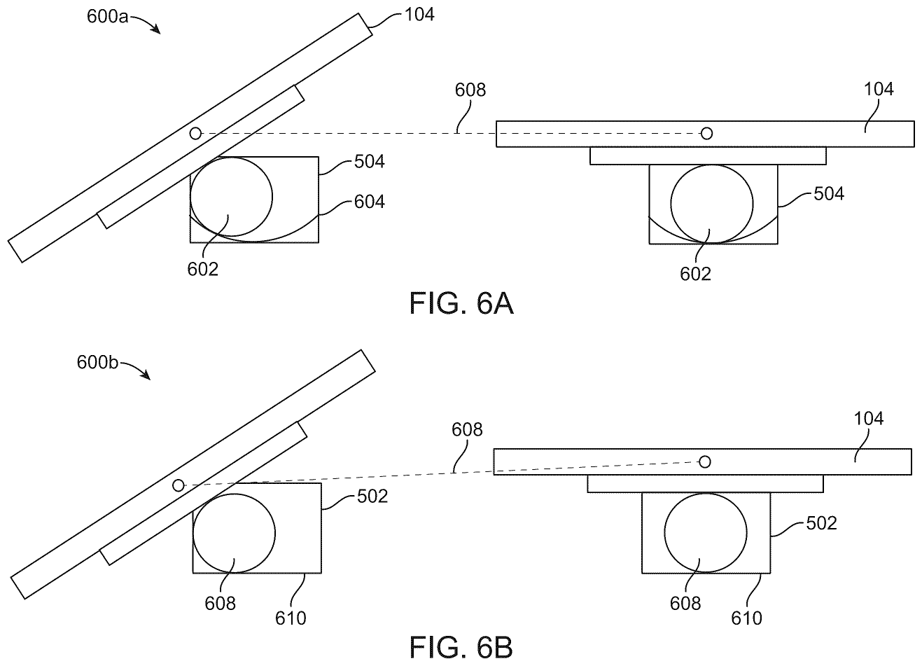

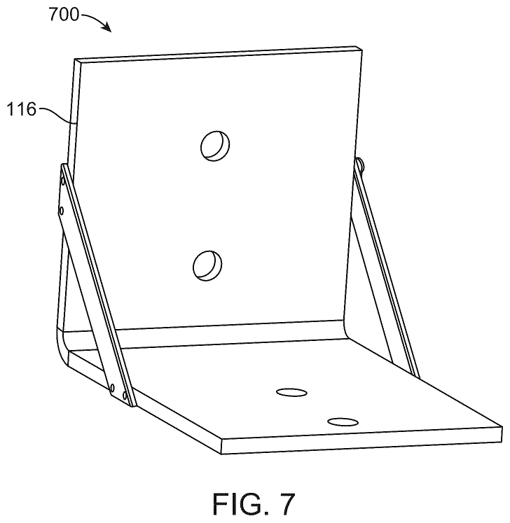

FIG. 6a illustrates a side view 600a of the rolling circle restraining plate 504 used in the solar power collection system 100, in accordance with an embodiment of the present subject matter. As shown in FIG. 6a, the photovoltaic (PV) panel 104 is shown coupled with a circular torque tube 602, which facilitates the rolling-rocking motion of the PV panel 102 necessary for solar tracking.

The circular torque tube 602 is secured within the rolling circle restraining plate 504. The rolling circle restraining plate 504 is configured with a curved torque tube base 604. The curvature of torque tube base 604 is configured to maintain the center of weight 608 of the PV panel 104 at a constant elevation throughout its motion. Such a configuration ensures that the potential energy of the system 100 remains unchanged during rolling-rocking movement of the PV panel 104. By keeping the center of weight 608 stable, the system is less affected by the external environmental forces like snow or wind.

Moreover, maintaining a constant center of weight 608 negates the need for additional force to return the PV panel 104 to a flat, neutral position after tilting. This reduces the energy required for repositioning and allows for a more efficient return to the starting orientation, ultimately leading to a system that is less susceptible to the destabilizing effects of snow or wind events.

FIG. 6b illustrates a side view 600b of the rolling circle restraining plate 504 used in the solar power collection system 100, in accordance with an embodiment of the present subject matter.

Notably, a torque tube base 610 of the restraining plate 502 is depicted as flat, contrasting with designs where the base is curved to maintain a consistent center of mass. As the PV panel 104 tilts to steeper angles to follow the sun's elevation changes, the center of weight 608 of the system correspondingly shifts downward in elevation. The change in the center of weight 608 requires additional force to be exerted to bring the PV panel 104 back to a horizontal or neutral position, especially in snow or wind conditions that exert pressures on the panel when it is angled.

The configuration presented in FIG. 6b is relevant to the design considerations of solar power systems, where the choice between a flat and a curved base can impact the system's energy efficiency and stability. The flat base 610 may necessitate more robust mechanisms to counteract the additional forces during the PV panel's repositioning, ensuring that the system remains operationally effective and secure in various environmental conditions.

FIG. 7 illustrates a perspective view of the wall/structure anchor 116 that connect the interconnecting row member 114 to a wall or fixed structure as an anchor point for the array.

What is claimed is:

1. A solar power collection system comprising:
at least one photovoltaic (PV) panel;
at least one single axis movable base coupled to the at least one PV panel; and
wherein the movable base facilitates tracking of sun by the at least one PV panel with a rolling-rocking movement, thereby orienting a receiving face of the at least one PV panel to face from east to west to efficiently receive sunlight; and
wherein the movable base is coupled to a fixed restraining structure that constrains a movement of the movable base to the rolling-rocking movement along a pre-defined path to facilitate the movement of the receiving face of the at least one PV panel to face from east to west; and
a tracker drive unit mechanically coupled to the movable base to impart a mechanical drive to facilitate the rolling-rocking movement of the movable base across a substrate to position the PV panel to efficiently receive sunlight.

2. The solar power collection system of claim 1, wherein a single axis row of PV panels is mounted to a torque tube base that performs a rolling-rocking motion within a fixed restraining structure, wherein the fixed restraining structure is configured to permit only the necessary movements of the torque tubes associated with tracking the sun from east to west, thereby optimizing energy capture and maintaining system stability.

3. The solar power collection system of claim 1, wherein a single axis row of PV panels is mounted to a torque tube base, which is attached to a curved rocking structure coupled to a fixed restraining structure.

4. The solar power collection system of claim 1, further comprising a restraining plate having a slot defining a travel path of a rocker component, wherein the rocker component is securely attached to the movable base having a curved rocking structure.

5. The solar power collection system of claim 1, wherein multiple single axis rows of PV panels are mechanically interconnected through a structural member, apart from the tracker drive unit, thereby enhancing stability of the solar power collection system against environmental forces.

6. The solar power collection system of claim 5, wherein the structural member is affixed to the movable base, thereby maintaining a consistent distance between the single axis rows of PV panels during tracking movements.

7. The solar power collection system of claim 5, further comprising a fixed restraining plate secured on the structural member, wherein the fixed restraining plate is coupled to the movable base of the multiple single axis rows of PV panels, further stabilizing the assembly.

8. The solar power collection system of claim 7, wherein the structural member is anchored in place by at least one of the following methods: (i) using ballast weight, (ii) securing to the floor, or (iii) attaching to an existing fixed structure, thereby restraining the structural member in a stationary position.

9. The solar power collection system of claim 3 where the curve profile in the torque tube base in which the torque tube is rolling is shaped to reduce the drop in elevation or even increase the elevation of the center of mass of the system when the panels are inclined at an angle ranging from about 90 degrees east to about 90 degrees west.

10. A solar power collection system, comprising:
an array of photovoltaic (PV) panels aligned in at least one single axis row for generating electricity from sunlight;
a tracker unit configured to operate a driveline, which rotates each single axis row east to west to track the sun;
at least one base supporting each PV single axis row, wherein the base is connected to an interconnecting row member that provides structural support to the array by utilizing the weight of each row to support adjacent rows during external force events;
wherein the interconnecting row member is attachable to a wall/structure anchor, a ballast tray, or a floor anchor, facilitating stability in various installation environments and reducing the need for floor attachments.
